(19) United States
(12) Patent Application Publication
(10) Pub. No.: US 2007/0274551 A1
(43) Pub. Date: Nov. 29, 2007

(54) Implantable Bone-Vibrating Hearing Aid

(75) Inventors: Cheng-Lun Tsai, Tao-Yuan (TW); Min-Chih Chen, Tao-Yuan (TW); Shih-Wei Pan, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, TAo-Yuan (TW)

(21) Appl. No.: 11/672,242

(22) Filed: Feb. 7, 2007

(30) Foreign Application Priority Data
May 24, 2006 (TW) 095118415

(51) Int. Cl. H04R 25/00

(52) U.S. Cl. 381/326

(57) ABSTRACT

The present invention proposes an implantable bone-vibrating hearing aid, including a transmitting coil for receiving an audio-converted signal and generating a corresponding magnetic field, a magnetic conducting element for sensing the corresponding magnetic filed to generate a driving force, and a vibrating module for receiving the driving force and generating a vibration, wherein the magnetic conducting element and the vibrating module are implanted beneath a skin of a user, and the vibration generated by the vibrating module knocks on the temporal bone of the ear of the user, which generates mechanical waves that propagate to the inner ear of the user, creating a sense of hearing thereto.

### BACKGROUND OF THE INVENTION

1. Field of the Invention

The present invention generally relates to hearing aids, and more particularly to an implantable bone-vibrating hearing aid.

2. Description of the Prior Art

Conventional Bone-Anchored Hearing Aid (BAHA) involves implanting a vibrating device made of titanium metal into the temporal bone of the ear of a user by surgery. However, the wound created will always exist and wound infection can be a potential problem. Also, such hearing aid is very expensive. In addition, a Japanese scholar named Shinji Hamanishi has invented a non-invasive electromagnetic-stimulated hearing aid (Shinji Hamanishi, Takuji Koike, Hidetoshi Matsuki, and Hiroshi Wada. “A New Electromagnetic Hearing Aid Using Lightweight Coils to Vibrate the Ossicles”, IEEE Trans. on Magnetics, vol. 40, No. 5, September 2004), in which the system structure includes a core, a driving and induction coil, a special magnet and vibrator coil. Within this system structure, the driving and induction coil, the magnet and the vibrator coil are disposed at the external ear canal, while the vibrator coil portion in the middle of the tympanic membrane. Accordingly, users have to undergo a more penetrating surgery in order to install this type of hearing aid.

In view of these problems, the present invention provides an implantable bone-vibrating hearing aid, which avoids problem associated with potential wound infection and is also cheaper than the BAHA. Advantageously, the surgery involved with the installation is relatively simple.

### SUMMARY OF THE INVENTION

Therefore, in accordance with the previous summary, elements, features and advantages of the present disclosure will become apparent to one skilled in the art from the subsequent description and the appended claims taken in conjunction with the accompanying drawings.

The present invention proposes an implantable bone-vibrating hearing aid, including a magnetic transmitting module for receiving an audio-converted signal and generating a driving force, this magnetic transmitting module including a transmitting coil for receiving the audio-converted signal and generating a corresponding magnetic field and a magnetic conducting element for sensing the corresponding magnetic filed to generate the driving force, and a vibrating module for receiving the driving force and generating a vibration, wherein the magnetic conducting element and the vibrating module are implanted beneath a skin of a user, and the vibration generated by the vibrating module knocks on the temporal bone of the ear of the user, which generates mechanical waves that propagate to the inner ear of the user, creating a sense of hearing thereto.

The present invention proposes an implantable bone-vibrating hearing aid, including a magnetic transmitting module for receiving an audio-converted signal and generating a driving force, the magnetic transmitting module including a transmitting coil for receiving the audio-converted signal and generating a corresponding magnetic field and a magnetic conducting element for sensing the corresponding magnetic filed to generate the driving force, a vibrating module for receiving the driving force and generating a vibration and an acoustic impedance element for receiving knockings of the vibration generated by the vibrating module, wherein the magnetic conducting element, the vibrating module and the acoustic impedance element are implanted beneath a skin of a user, and the acoustic impedance element is in close contact with the temporal bone of the ear of the user, thereby enhancing the transmission of knocking energy of the vibrating module.

The present invention proposes an implantable bone-vibrating hearing aid, including a microphone for receiving an audio signal and outputting a converted signal, a power amplifier for receiving and amplifying the converted signal to output an audio-converted signal, a transmitting coil for receiving the audio-converted signal and generating a corresponding magnetic field, a magnetic conducting element for sensing the corresponding magnetic filed to generate the driving force, a vibrating module for receiving the driving force and generating a vibration, and an acoustic impedance element for receiving knockings of the vibration generated by the vibrating module, wherein the magnetic conducting element, the vibrating module and the acoustic impedance element are implanted beneath a skin of a user, and the acoustic impedance element is in close contact with the temporal bone of the ear of the user, thereby enhancing the transmission of knocking energy of the vibrating module.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a system block diagram of a preferred embodiment of the present invention;

FIG. 2A is a cross-sectional diagram depicting a preferred embodiment of the transmitting coil of the present invention;

FIG. 2B is a perspective diagram depicting a preferred embodiment of the transmitting coil of the present invention; and

FIG. 3 is a schematic diagram illustrating a preferred application of the present invention.

### DETAILED DESCRIPTION OF THE PREFERRED EMBODIMENTS

The present invention will be described in the following with certain embodiments thereof. However, in addition to the disclosed embodiments, the present invention can be widely implemented in other embodiments. The scope of the present invention is not limited to the embodiments set forth, but are construed to be defined in the appended claims. In order to provide a more lucid description and a better understanding of the present invention to those with ordinary skill in the art, some portions of the diagrams are not drawn to scale, while some may be exaggerated and/or irrelevant parts omitted for clarity.

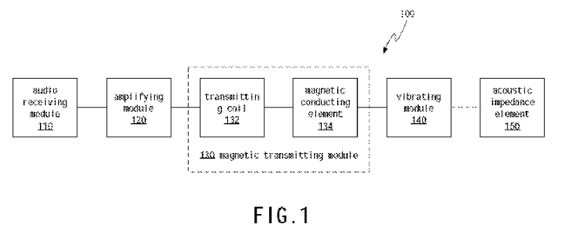

Referring to FIG. 1, a system block diagram of a preferred embodiment 100 of the present invention is shown. An audio receiving module 110 receives audio signal and outputs a converted signal, in this embodiment, the audio receiving module 110 may be a microphone or a sound source generator. An amplifying module 120 receives and amplifies the converted signal outputted by the audio receiving module 110 to output an audio-converted signal. The amplifying module 120 includes a power amplifier. The above audio-converted signal is a current signal corresponding to the audio signal received by the audio receiving module 110. In this embodiment, the amplifying module 120 is a Class-D power amplifier, and the output impedance is 4 ohms. A magnetic transmitting module 130 receives the above audio-converted signal and generates a driving force, wherein the magnetic transmitting module 130 includes a transmitting coil 132 and a magnetic conducting element 134. The transmitting coil 132 receives the audio-converted signal (current signal) and generates a corresponding magnetic field. The magnetic conducting element 134 senses this corresponding magnetic field and generates the driving force. A vibrating module 140 receives the driving force generated by the magnetic transmitting module 130 and generates a vibration with amplitude corresponding to the magnitude of the driving force. The magnetic conducting element 134 and the vibrating module 140 are implanted beneath the skin, and the vibration generated by the vibrating module 140 knocks on the temporal bone of the ear, so as to generate mechanical waves that reach the inner ear in order to create a sense of hearing for a user. The main difference of the present invention and the conventional bone-anchored hearing aid is in that the wound created as a result of the surgical implant of the hearing aid of the present invention can be sewed, and audio signal is transmitted from the external magnetic field transmitter to the inner sensing device via magnetic coupling, which in turns allows the vibrating module 140 to knock on the temporal bone, thus generating mechanical waves that propagate to the three ossicles the inner ear due to a bone conducting property, thereby creating a sense of hearing.

Additionally, this embodiment may further include an acoustic impedance element 150. The acoustic impedance element 150 receives knockings of the vibrations generated by the vibrating module 140, wherein the acoustic impedance element 150 is positioned between the vibrating module 140 and the temporal bone and in close contact with the temporal bone. The acoustic impedance element 150 is used for acoustic impedance matching of the vibrating module 140 and the temporal bone, thereby enhancing the transmission of knocking energy of the vibrating module 150.

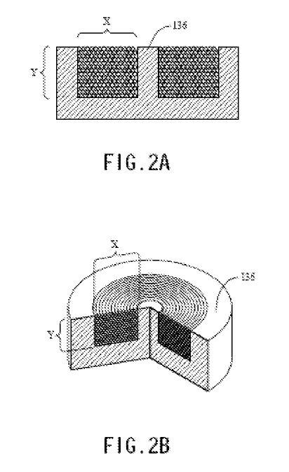

Referring now to FIGS. 2A and 2B, a cross-sectional view and a perspective view of a preferred embodiment of the transmitting coil of the present invention are shown, respectively. In this embodiment, a magnetic powder core 136 is wound to the transmitting coil illustrated in FIG. 1. The ratio of the number of windings X and the number of layers Y of the transmitting coil is 1:1. The impedance of the transmitting coil and the output impedance of the amplifying module shown in FIG. 1 must be impedance matched to reduce loss of the transmitted energy. In this embodiment, the transmitting coil adopts No. 35 enameled wires with an impedance of 4 ohms, and the numbers of windings and layers are both 14. However, the abovementioned values are only used to illustrate the present embodiment; implementations of the present invention are not limited to these.

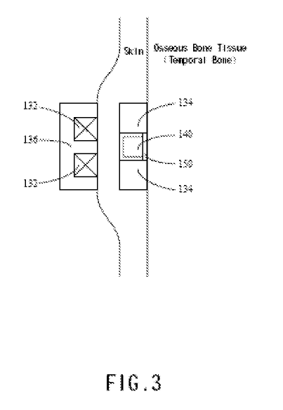

Referring to FIG. 3, a schematic diagram showing a preferred application of the present invention. An external magnetic field transmitter includes the magnetic powder core 136 and the transmitting coil 132, wherein the transmitting coil 132 is wound to the magnetic powder core 136, the ratio of the number of windings and of layers is 1:1. The above external magnetic field transmitter is disposed outside the skin when in use. An internal device includes the magnetic conducting element 134, the vibrating module 140 and the acoustic impedance element 150, wherein the magnetic conducting element 134 senses the magnetic field formed by the transmitting coil 132 and generates a corresponding driving force to drive the vibrating module 140 to vibrate. The vibrating module 140 generates a vibration with amplitude corresponding to the magnitude of the driving force. The acoustic impedance element 150 then receives knockings of the vibrations generated by the vibrating module 140, wherein the acoustic impedance element 150 is positioned between the vibrating module 140 and the temporal bone and in close contact with the osseous bone tissue (the temporal bone). The acoustic impedance element 150 is used for acoustic impedance matching of the vibrating module 140 and the temporal bone, thereby enhancing the transmission of knocking energy of the vibrating module 150. In this embodiment, the vibrating module 140 can be one made of a magnetic material.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. An implantable bone-vibrating hearing aid, including:
a magnetic transmitting module for receiving an audio-converted signal and generating a driving force, the magnetic transmitting module including:
a transmitting coil for receiving the audio-converted signal and generating a corresponding magnetic field; and
a magnetic conducting element for sensing the corresponding magnetic filed to generate the driving force; and
a vibrating module for receiving the driving force and generating a vibration,
wherein the magnetic conducting element and the vibrating module are implanted beneath a skin of a user, and the vibration generated by the vibrating module knocks on the temporal bone of the ear of the user, which generates mechanical waves that propagate to the inner ear of the user, creating a sense of hearing thereto.

2. An implantable bone-vibrating hearing aid of claim 1, wherein the transmitting coil is wound to a magnetic powder core.

3. An implantable bone-vibrating hearing aid of claim 1, wherein a ratio of the number of windings and the number of layers of the transmitting coil is 1:1.

4. An implantable bone-vibrating hearing aid of claim 1, wherein the vibrating module includes a magnet.

5. An implantable bone-vibrating hearing aid of claim 1, further comprising:
an audio receiving module for receiving an audio signal and outputting a converted signal; and
an amplifying module for receiving and amplifying the converted signal to output an audio-converted signal.

6. An implantable bone-vibrating hearing aid of claim 5, wherein the impedance of the transmitting coil is impedance matched with the output impedance of the amplifying module.

7. An implantable bone-vibrating hearing aid, including:
a magnetic transmitting module for receiving an audio-converted signal and generating a driving force, the magnetic transmitting module including:
a transmitting coil for receiving the audio-converted signal and generating a corresponding magnetic field; and
a magnetic conducting element for sensing the corresponding magnetic filed to generate the driving force;
a vibrating module for receiving the driving force and generating a vibration; and
an acoustic impedance element for receiving knockings of the vibration generated by the vibrating module,
wherein the magnetic conducting element, the vibrating module and the acoustic impedance element are implanted beneath a skin of a user, and the acoustic impedance element is in close contact with the temporal bone of the ear of the user, thereby enhancing the transmission of knocking energy of the vibrating module.

8. An implantable bone-vibrating hearing aid of claim 7, wherein the transmitting coil is wound to a magnetic powder core.

9. An implantable bone-vibrating hearing aid of claim 7, wherein a ratio of the number of windings and the number of layers of the transmitting coil is 1:1.

10. An implantable bone-vibrating hearing aid of claim 7, wherein the vibrating module includes a magnet.

11. An implantable bone-vibrating hearing aid of claim 7, further comprising:
an audio receiving module for receiving an audio signal and outputting a converted signal; and
an amplifying module for receiving and amplifying the converted signal to output an audio-converted signal.

12. An implantable bone-vibrating hearing aid of claim 11, wherein the impedance of the transmitting coil is impedance matched with the output impedance of the amplifying module.

13. An implantable bone-vibrating hearing aid, including:
a microphone for receiving an audio signal and outputting a converted signal;
a power amplifier for receiving and amplifying the converted signal to output an audio-converted signal;
a transmitting coil for receiving the audio-converted signal and generating a corresponding magnetic field;
a magnetic conducting element for sensing the corresponding magnetic filed to generate the driving force;
a vibrating module for receiving the driving force and generating a vibration; and
an acoustic impedance element for receiving knockings of the vibration generated by the vibrating module,
wherein the magnetic conducting element, the vibrating module and the acoustic impedance element are implanted beneath a skin of a user, and the acoustic impedance element is in close contact with the temporal bone of the ear of the user, thereby enhancing the transmission of knocking energy of the vibrating module.

14. An implantable bone-vibrating hearing aid of claim 13, wherein the transmitting coil is wound to a magnetic powder core.

15. An implantable bone-vibrating hearing aid of claim 13, wherein a ratio of the number of windings and the number of layers of the transmitting coil is 1:1.

16. An implantable bone-vibrating hearing aid of claim 13, wherein the vibrating module includes a magnet.

17. An implantable bone-vibrating hearing aid of claim 13, wherein the impedance of the transmitting coil is impedance matched with the output impedance of the power amplifier.
